(19) United States
(12) Patent Application Publication
(10) Pub. No.: US 2011/0310169 A1
(43) Pub. Date: Dec. 22, 2011

(54) INKJET HEAD UNIT

(75) Inventors: Nobuaki Takahashi, Shizuoka-ken (JP); Satoshi Kaiho, Kanagawa-ken (JP); Hiroshi Murata, Tokyo-to (JP); Takashi Hatakeyama, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/159,633

(22) Filed: Jun. 14, 2011

Related U.S. Application Data
(60) Provisional application No. 61/355,836, filed on Jun. 17, 2010.

(51) Int. Cl. B41J 2/165

(52) U.S. Cl. 347/29

(57) ABSTRACT

According to one embodiment, a maintenance unit includes an inkjet head and a cap. The inkjet head includes plural nozzle arrays and discharges a different color of ink from each of the plural nozzle arrays. The cap includes plural protrusions at positions facing the plural nozzle arrays, includes a groove between the plural protrusions, and tightly closes the plural nozzle arrays with the plural protrusions.

### CROSS-REFERENCE TO RELATED APPLICATIONS

This application is based upon and claims the benefit of priority from Provisional Application No. 61/355,836, filed on Jun. 17, 2010, the entire contents of which are incorporated herein by reference.

### FIELD

Embodiments described herein relate generally to an image forming apparatus including an inkjet head and a maintenance device.

### BACKGROUND

Conventionally, there is a type of image forming apparatus in which a cap is made to tightly adhere to a nozzle surface (orifice plate) of an inkjet head during a standby state. The cap is for protecting the nozzle plane from paper powder, dust, and the like and avoiding drying of the nozzle surface.

As well as a type of inkjet head in which one inkjet head discharges one color of ink, there is also a type of inkjet head in which one inkjet head discharges plural colors of ink. If the cap tightly adheres to the entire nozzle surface of the inkjet head according to the latter type, plural colors of ink are mixed with each other through the nozzle surface. As a result, the plural colors of ink react with each other, or a desirable color of ink is not discharged from the inkjet head in some cases.

### BRIEF DESCRIPTION OF THE DRAWINGS

FIG. 1 is a diagram illustrating an image forming apparatus according to an embodiment.

FIG. 2 is a diagram showing an overview of an inkjet head according to an embodiment.

FIG. 3 is a diagram showing an overview of a cap unit according to an embodiment.

FIG. 4 is a block diagram showing a control system of an image forming apparatus according to an embodiment.

FIG. 5 is a flowchart illustrating an operation of a maintenance apparatus according to an embodiment.

FIG. 6 is a diagram showing a state in which a cap unit according to an embodiment abuts on a nozzle plane.

FIG. 7 is a diagram illustrating ink charging into an inkjet head according to an embodiment.

### DETAILED DESCRIPTION

In general, according to one embodiment, an inkjet head unit includes an inkjet head and a cap. The inkjet head includes plural nozzle arrays and discharges ink with a different color from each of the plural nozzle arrays. The cap includes plural protrusions at positions facing the plural nozzle arrays, includes a groove between the plural protrusions, and tightly closes the plural nozzle arrays with the plural protrusions.

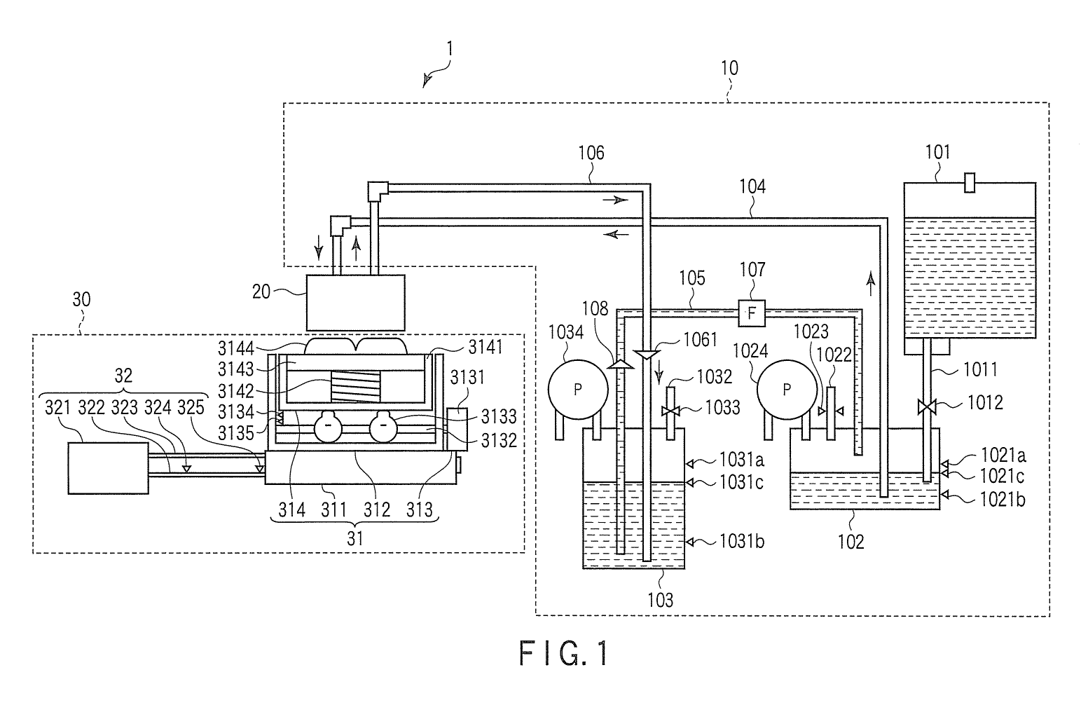

Hereinafter, description will be made of an embodiment with reference to accompanying drawings. FIG. 1 is a diagram illustrating an image forming apparatus 1 according to an embodiment. The image forming apparatus 1 includes an ink tank apparatus 10, an inkjet head 20, and a maintenance apparatus 30. In this embodiment, the inkjet head 20 and the maintenance apparatus 30 are integrally referred to as an inkjet head unit.

First, description will be made of a configuration of the ink tank apparatus 10. The ink tank apparatus 10 is an ink supply system which supplies ink to the inkjet head 20. The ink tank apparatus 10 includes a main tank (cartridge) 101, an upstream-side tank (first ink tank) 102, and a downstream-side tank (second ink tank) 103. The main tank 101 stores arbitrary colors of ink. The main tank 101 is open to atmospheric pressure. The main tank 101 includes a tube 1011 which supplies ink to the upstream-side tank 102. Furthermore, the tube 1011 includes a valve 1012. The ink within the main tank 101 flows to the upstream-side tank 102, if the valve 1012 opens.

Next, description will be made of a configuration of the upstream-side tank 102. The upstream-side tank 102 temporarily stores ink before being supplied to the inkjet head 20. The upstream-side tank 102 is an airtight container. The upstream-side tank 102 includes fluid level sensors 1021a, 1021b, and 1021c, a tube 1022, a valve 1023, and a first ink supply pump 1024.

The fluid level sensors 1021a, 1021b, and 1021c are respectively provided in this order from the highest position from the bottom surface of the upstream-side tank 102. The fluid level sensor 1021a is provided at a position which corresponds to the upper limit of the ink stored in the upstream-side tank 102 such that the ink tank apparatus 10 operates normally. The fluid level sensor 1021b is provided at a position which corresponds to the lower limit of the ink stored in the upstream-side tank 102 such that the ink tank apparatus 10 operates normally. The fluid level sensor 1021c is provided between the fluid level sensors 1021a and 1021b at an optimal position for the normal operation of the ink tank apparatus 10. The fluid level sensors 1021a, 1021b, and 1021c respectively detect the presence of the ink. The tube 1022 causes the inside of the upstream-side tank 102 to communicate with atmosphere. The valve 1023 is provided in the tube 1022. The inside of the upstream-side tank 102 communicates with atmosphere, if the valve 1023 opens. The first ink supply pump 1024 suctions the air within the upstream-side tank 102. The first ink supply pump 1024 operates and generates negative pressure inside the upstream-side tank 102.

In addition, the ink tank apparatus 10 includes a tube 104 which supplies ink stored in the upstream-side tank 102 to the inkjet head 20. One end of the tube 104 is separated from the bottom surface of the upstream-side tank 102 by a predetermined distance. The other end of the tube 104 is connected to the inkjet head 20. Furthermore, the ink tank apparatus 10 includes a tube 105 which flows back the ink stored in the downstream-side tank 103 to the upstream-side tank 102. One end of the tube 105 is separated from the bottom surface of the upstream-side tank 102 by a predetermined distance.

Next, description will be made of a configuration of the downstream-side tank 103. The downstream-side tank 103 circulates the inside of the inkjet head 20 and then temporarily stores the ink discharged from the inkjet head 20. The downstream side tank 103 is an airtight container. The downstream-side tank 103 includes fluid level sensors 1031a, 1031b, and 1031c, a tube 1032, a valve 1033, and a second ink supply pump 1034.

The fluid level sensors 1031a, 1031b, and 1031c are respectively provided in this order from the highest position from the bottom surface of the downstream-side tank 103. The fluid level sensor 1031a is provided at a position which corresponds to the upper limit of the ink stored in the downstream-side tank 103 such that the ink tank apparatus 10 operates normally. The fluid level sensor 1031b is provided at a position which corresponds to the lower limit of the ink stored in the downstream-side tank 103 such that the ink tank apparatus 10 operates normally. The fluid level sensor 1031c is provided between the fluid level sensors 1031a and 1031b at an optimal position for the normal operation of the ink tank apparatus 10. The fluid level sensors 1031a, 1031b, and 1031c respectively detect the presence of the ink.

The tube 1032 causes the inside of the downstream-side tank 103 to communicate with atmosphere. The valve 1033 is provided in the tube 1032. The inside of the downstream-side tank 103 communicates with atmosphere, if the valve 1033 opens. The second ink supply pump 1034 suctions the air within the downstream-side tank 103. The second ink supply pump 1034 operates and generates negative pressure inside the downstream-side tank 103.

In addition, the ink tank apparatus 10 includes a tube 106 which stores ink which flows from the inkjet head 20 in the downstream-side tank 103. One end of the tube 106 is separated from the bottom surface of the downstream-side tank 103 by a predetermined distance. The other end of the tube 106 is connected to the inkjet head 20. The tube 106 includes a back-flow prevention valve 1061. The back-flow prevention valve 1061 prevents the ink from flowing back from the downstream-side tank 103 to the inkjet head 20. Furthermore, the other end of the tube 105 is separated from the bottom surface of the downstream-side tank 103 by a predetermined distance. Accordingly, the ink stored in the downstream-side tank 103 flows to the upstream-side tank 102 through the tube 105. The tube 105 includes a filter 107 and a back-flow prevention valve 108. The filter 107 removes foreign matter included in the ink. The back-flow prevention valve 108 prevents the ink from flowing back from the upstream-side tank 102 to the downstream-side tank 103.

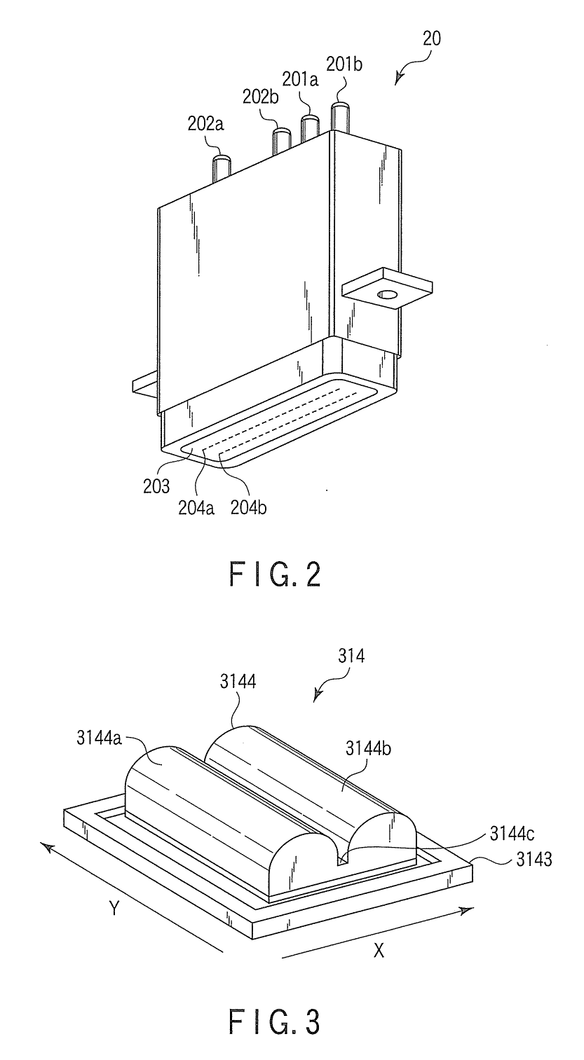

Next, description will be made of a configuration of the inkjet head 20. FIG. 2 is a diagram showing an overview of the inkjet head 20. The inkjet head 20 is based on an ink circulation scheme. The inkjet head 20 is fixed to the image forming apparatus 1. The inkjet head 20 can form an image on a paper (medium) by flying plural colors of ink without mixing. In addition, although FIG. 1 shows an example in which only one inkjet head 20 is provided for the tubes 104 and 106, plural inkjet heads may be provided in parallel for the tubes 104 and 106. The number of the inkjet heads provided in the image forming apparatus 1 is arbitrarily determined based on the image formation range of the inkjet head, resolution, the number of colors to be used in the image forming apparatus 1, and the like.

Next, description will be made of the inkjet head 20 with reference to FIG. 2. FIG. 2 is a diagram showing an overview of the inkjet head 20. The inkjet head 20 includes supply ports 201a and 201b, discharge ports 202a and 202b, a nozzle surface (orifice plate) 203, and nozzle arrays 204a and 204b. The supply ports 201a and 201b are for supplying ink into the inkjet head 20. The discharge ports 202a and 202b are for discharging ink from the inside of the inkjet head 20. The nozzle surface 203 includes the nozzle arrays 204a and 204b, each of which is constituted by plural nozzles. The nozzle surface 203 faces a paper convey surface in the image forming apparatus 1. The plural nozzles constituting the nozzle arrays 204a and 204b discharge ink.

The inkjet head 20 can discharge two colors of ink. The inside of the inkjet head 20 is split into two regions including a first region and a second region, each of which can be charged with two colors of ink. The first region in the inkjet head 20 communicates with the supply port 201a, the discharge port 202a, and the nozzle array 204a. The second region in the inkjet head 20 communicates with the supply port 201b, the discharge port 202b, and the nozzle array 204b. In addition, although only one ink tank apparatus 10 is shown in FIG. 1, another ink tank apparatus, which is not shown in FIG. 1, as well as the ink tank apparatus 10 is required for the image forming apparatus 1 if the inkjet head 20 discharges two colors of ink. Another ink tank apparatus has the same configuration as that of the ink tank apparatus 10. Another ink tank apparatus stores ink with a different color from that of the ink stored in the ink tank apparatus 10.

The supply port 201a is connected to the tube 104, and the discharge port 202a is connected to the tube 106. The supply port 201b is a tube provided in another ink tank apparatus and connected to a tube corresponding to the tube 104. The discharge port 202b is a tube provided in another ink tank apparatus and connected to a tube corresponding to the tube 106. Accordingly, different colors of ink are charged in the first and second regions in the inkjet head 20. The nozzle arrays 204a and 204b respectively discharge different colors of ink.

According to this embodiment, the image forming apparatus 1 includes the ink tank apparatuses 10, the number of which corresponds to the number of ink colors discharged from the inkjet head 20. One inkjet head 20 has plural nozzle arrays and can discharge different colors of ink, the maximum number of which corresponds to the number of the nozzle arrays.

Next, referring back to FIG. 1, description will be made of the maintenance apparatus 30. The maintenance apparatus 30 includes a maintenance unit 31 and a driving unit 32. The maintenance unit 31 actually performs maintenance on the inkjet head 20. The driving unit 32 moves and retreats the maintenance unit 31 to and from the inkjet head 20.

The maintenance unit 31 includes a stage 311, an outer frame unit 312, a cam mechanism unit 313, and a cap unit 314. The stage 311 is a table on which the outer frame unit 312 is placed. The outer frame unit 312 is a box-shaped member with an opening in its upper portion.

The cam mechanism unit 313 moves the cap unit 314 upward and downward in the vertical direction. The cam mechanism unit 313 includes a drive source motor 3131, a shaft 3132, a planer cam 3133, sensors 3134 and 3135. The drive source motor 3131 is provided outside the outer frame unit 312. The drive source motor 3131 drives the shaft 3132. The shaft 3132 is attached to the drive source motor 3131. The shaft 3132 is parallel to the moving direction of the stage 311 and extends so as to penetrate through the inside of the outer frame unit 312. The shaft 3132 rotates in accordance with the driving of the drive source motor 3131. The planar cam 3131 is provided in the outer frame unit 312. The planar cam 3133 is fixed to the shaft 3132. The planar cam 3133 moves the cap unit 314 upward and downward in the vertical direction in accordance with the driving of the drive source motor 3131. The sensors 3134 and 3135 are provided in the outer frame unit 312. The sensor 3134 is provided above the sensor 3135. The sensor 3134 is provided at a position at which the sensor 3134 can detect that the cap unit 314 was moved upward to the maximum extent by the planer cam 3133 (that is, that the cap unit 314 tightly adheres to the nozzle surface 203). The sensor 3135 is provided at a position at which the sensor 3135 can detect that the cap unit 314 was moved downward to the maximum extent by the planer cam 3133 (that is, that the cap unit 314 is separated from the nozzle surface 203).

Next, description will be made of the cap unit 314 with reference to FIG. 3. FIG. 3 is a diagram showing an overview of the cap unit 314. The cap unit 314 tightly adheres to the nozzle surface 203 and thereby tightly closes the nozzle arrays 204a and 204b of the inkjet head 20. The cap unit 314 includes an inner frame unit 3141, a spring unit 3142, a base unit 3143, an elastic member (cap) 3144. The inner frame unit 3141 includes an opening in the upper portion and is a box-shaped member with a size which can be accommodated within the outer frame unit 312. The bottom surface of the inner frame unit 3141 is in a contact with the planer cam 3133. The inner frame unit 3141 moves upward and downward in the vertical direction in accordance with the operation of the planer cam 3133. The spring unit 3142 is provided between the bottom surface within the outer frame unit 312 and the bottom surface of the base unit 3143. The spring unit 3142 applies appropriate pressure on the inkjet head 20 through the elastic member 3144. In addition, the spring unit 3142 is not limited to a spring, and another elastic member with elasticity in the vertical direction may be used. The base unit 3143 is a plate-shaped member with a size which can be accommodated in the inner frame unit 3141. The base unit 3143 can slide upward and downward in the vertical direction with respect to the inner frame unit 3141. The elastic member 3144 is fixed on the upper surface of the base unit 3143. The surface of the base unit 3143 on which the elastic member 3144 is fixed has a size which is larger than the fixing surface of the elastic member 3144. The base unit 3143 includes a side wall surrounding the four sides of the surface on which the elastic member 3144 is fixed.

The elastic member 3144 includes a first protrusion 3144a, a second protrusion 3144b, and a groove 3144c. The elastic member 3144 is a rubber member with resistance to ink solvent used in the ink tank apparatus 10. The elastic member 3144 is EPDM (rubber hardness of 30 to 60), for example. The first and second protrusions 3144a and 3144b protrude further in the vertical direction than the groove 3144c.

Next, description will be made of the configuration of first protrusion 3144a. The longitudinal direction (Y direction shown in FIG. 3) of the first protrusion 3144a is parallel to the arrangement direction of the nozzles constituting the nozzle array 204a. The size of the upper portion in the longitudinal direction of the first protrusion 3144a is equal to or greater than the length of the nozzle array 204a of the inkjet head 20. The first protrusion 3144a includes an arc-shaped surface on its upper portion, in which the center in the width direction (X direction perpendicular to the Y direction shown in FIG. 3) corresponds to the peak. The first protrusion 3144a includes surfaces which are parallel to the vertical direction on the both sides in the width direction. The first protrusion 3144a includes the surfaces perpendicular to the longitudinal direction on the both sides in the longitudinal direction. In addition, the first protrusion 3144a may include a plane with a size in the width direction, which is equal to or greater than the diameter of each nozzle constituting the nozzle array 204a on the upper portion. The first protrusion 3144a may include an arc-shaped plane on at least one side in the width direction. The arc-shaped surface may be a curve surface protruding from the center of the width direction or a curve surface with a recess toward the center of the width direction. The first protrusion 3144a may include an inclined plane facing the center in the width direction from the downward to the upward in the vertical direction on at least one side of the width direction. Similarly, the first protrusion 3144a may include an arc-shaped or inclined plane on at least one side of the longitudinal direction.

The second protrusion 3144b has the same configuration as that of the first protrusion 3144a. The interval between the center position in the width direction of the first protrusion 3144a and the center position in the width direction of the second protrusion 3144b is substantially the same as the interval between the nozzle array 204a and the nozzle array 204b of the inkjet head 20. That is, if the cap unit 314 abuts on the nozzle surface 203, the upper portion of the first protrusion 3144a faces the nozzle array 204a while the upper portion of the second protrusion 3144b faces the nozzle array 204b.

The groove 3144c is provided between the first protrusion 3144a and the second protrusion 3144b in the X direction. The groove 3144c is inclined from one side to the other side in the Y direction. If the cap unit 314 abuts on the nozzle surface 203, the groove 3144c does not face the nozzle arrays 204a and 204b.

In addition, if the inkjet head 20 includes three or more nozzle arrays, the elastic member 3144 includes the protrusions, the number of which is the same as the number of the nozzle arrays. In this case, the elastic member 3144 includes protrusions with intervals with which the upper portion of each protrusion faces each nozzle array, if the cap unit 314 abuts on the nozzle surface 203.

The driving unit 32 includes a drive source motor 321, a linear shaft 322, a driving belt 323, and sensors 324 and 325. The drive source motor 321 drives the driving belt 323. The linear shaft 322 supports the stage 311. The driving belt 323 moves the maintenance unit 31 in the horizontal direction in accordance with the driving of the drive source motor 321. The driving belt 323 moves the maintenance unit 31 from the position where the maintenance unit 31 does not face the inkjet head 20 to the position where the maintenance unit 31 faces the inkjet head 20 in accordance with the driving of the drive source motor 321. Alternatively, the driving belt 323 retreats the maintenance unit 31 from the position where the maintenance unit 31 faces the inkjet head 20 to the position where the maintenance unit 31 does not face the inkjet head 20 in accordance with the driving of the drive source motor 321. The sensors 324 and 325 are provided on the linear shaft 322. The sensor 324 is provided on the side closer to the drive source motor 321 than the sensor 325. The sensor 324 is provided at a position at which the sensor 324 can detect that the maintenance unit 31 is at a position where the maintenance unit 31 does not face the inkjet head 20. The sensor 325 is provided at a position at which the sensor 325 can detect that the maintenance unit 31 is at the position where the maintenance unit 31 faces the inkjet head 20.

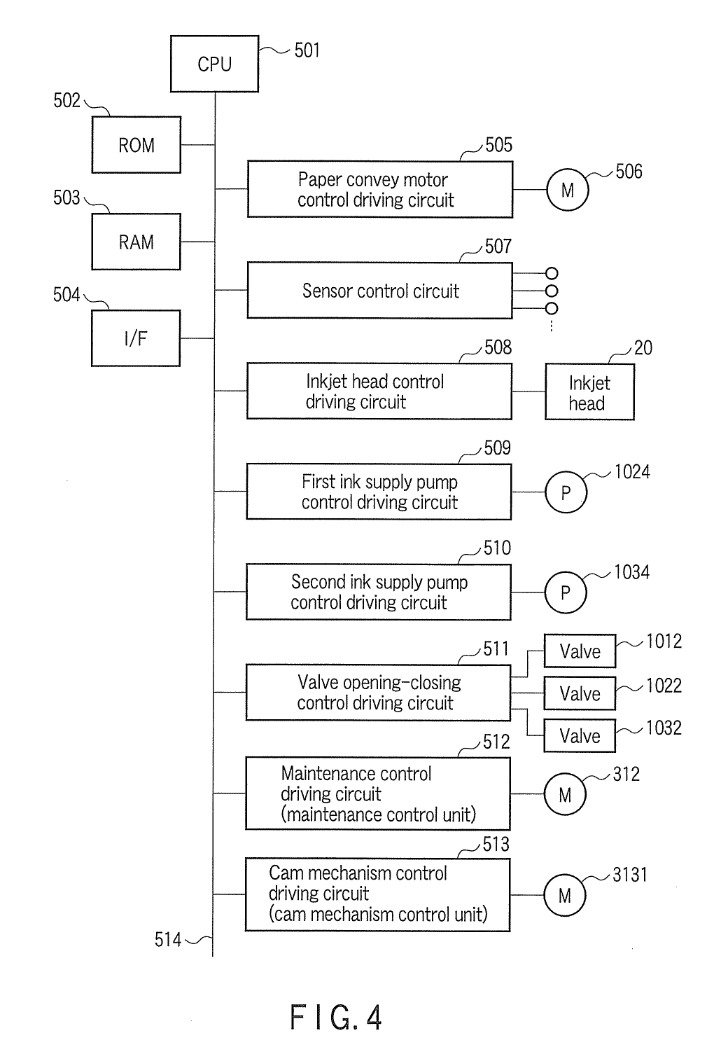

FIG. 4 is a block diagram showing a control system of the image forming apparatus 1 according to an embodiment. The image forming apparatus 1 includes a CPU (controller) 501, a ROM 502, a RAM 503, an I/F 504, a paper convey motor control driving circuit 505, a sensor control circuit 507, an inkjet head control driving circuit 508, a first ink supply pump control driving circuit 509, a second ink supply pump control driving circuit 510, a valve opening-closing control driving circuit 511, a maintenance control driving circuit 512, a cam mechanism control driving circuit 513, and the like.

The CPU 501 controls the operation of each component connected via a CPU bus 514. The ROM 502 stores various programs executed by the CPU 501. The RAM 503 stores various items of data. The I/F 504 connects an external computer to a CPU bus 514. The I/F 504 receives printing instruction and image data sent from the external computer to the image forming apparatus 1. The paper convey motor control driving circuit 505 drives and controls a paper convey motor 506 under the control of the CPU 501. The paper convey motor 506 drives plural rollers provided in the image forming apparatus 1 in order to supply, convey, and discharge a paper during a printing operation. The sensor control circuit 507 controls the fluid level sensors 1021a, 1021b, and 1021c, the fluid level sensors 1031a, 1031b, and 1031c, the sensors 3134 and 3135, and the sensors 324 and 325 under the control of the CPU 501. The inkjet head control driving circuit 508 controls ink discharge from the inkjet head 20 in synchronization with the paper convey operation based on the image data under the control of the CPU 501. The first ink supply pump control driving circuit 509 drives the first ink supply pump 1024 under the control of the CPU 501. The second ink supply pump control driving circuit 510 drives the second ink supply pump 1034 under the control of the CPU 501. The valve opening-closing control driving circuit 511 independently opens and closes the valves 1012, 1023, and 1033 under the control of the CPU 501.

The maintenance control driving circuit 512 is a maintenance control unit which controls the driving unit 32. The maintenance control driving circuit 510 drives the drive source motor 321 under the control of the CPU 501. The cam mechanism control driving circuit 513 is a cam mechanism control unit which drives the cam mechanism 31. The cam mechanism control driving circuit 513 drives the driving source motor 3131 under the control of the CPU 501.

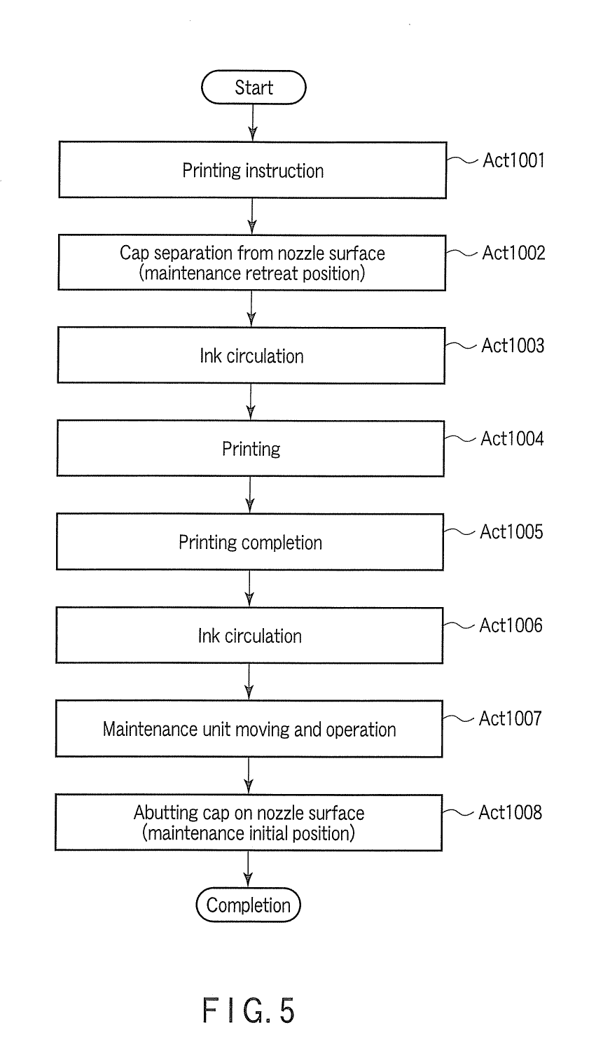

Next, description will be made of the operation of the maintenance apparatus 30 during the printing operation of the image forming apparatus 1. FIG. 5 is a flowchart illustrating the operation of the maintenance apparatus 30. First, the CPU 501 receives a printing instruction from the external computer (Act 1001). The CPU 501 controls the cap unit 314 so as to be separated from the nozzle surface 203 (Act 1002). In Act 1002, the CPU 501 controls the cam mechanism unit 313 to move downward the cap unit 314 such that the cap unit 314 abutting on the nozzle surface 203 is separated from the nozzle surface 203. In this embodiment, the position of the maintenance unit 31 where the cap unit 314 abuts on the nozzle surface 203 is assumed to be a maintenance initial position. Thereafter, the CPU 501 controls the driving unit 32 to move the maintenance unit 31 in the horizontal direction up to the position where the maintenance unit 31 does not face the inkjet head 20 (that is, the position where the maintenance unit 31 does not disturb the printing operation of the inkjet head 20). In this embodiment, a predetermined position of the maintenance unit 31 where the maintenance unit does not disturb the printing operation of the inkjet head 20 is assumed to be a maintenance retreat position.

The CPU 501 controls an ink circulation operation performed on the inkjet head 20 by the ink tank apparatus 10 (Act 1003). In Act 1003, the CPU 501 controls the first ink supply pump 1024, the second ink supply pump 1034, and the valves 1023 and 1033 so as to change the pressure within the upstream-side tank 102 and the downstream-side tank 103. As a result, the ink stored in the upstream-side tank 102 flows back to the upstream-side tank 102 through the inkjet head 20 and the downstream-side tank 103. Through the ink circulation operation in Act 1003, the negative pressure within the inkjet head 20 is recovered and maintained in an appropriate state. Since dust, paper powder, and the like entered into the nozzle are removed by the circulating ink, the inkjet head 20 is brought into a state suitable for printing.

The CPU 501 controls the inkjet head 20 to discharge ink and perform printing on the paper based on the image data (Act 1004). The CPU 501 completes printing based on the printing instruction (Act 1005). Thereafter, the CPU 501 controls the ink circulation operation performed on the inkjet head 20 by the ink tank apparatus 10 in the same manner as in Act 1003 (Act 1006).

The CPU 501 controls the maintenance unit 31 at the maintenance retreat position to move in the horizontal direction up to the position where the maintenance unit 31 faces the inkjet head 20 (Act 1007). In Act 1007, the CPU 501 further controls the inkjet head 20 to discharge ink. This is because foreign particles around the nozzle are forcibly discharged by the ink discharge of the inkjet head 20. Accordingly, the nozzle surface 203 is cleaned up. Another example is also applicable in which the CPU 501 causes a blade provided in the maintenance unit 31 to wipe off the nozzle surface 203 in Act 1007.

Thereafter, the CPU 501 controls the cap unit 314 so as to abut on the nozzle surface 203 (Act 1008). In Act 1008, the CPU 501 controls the cam mechanism unit 313 to move the cap unit 314 in the vertical direction up to the maintenance initial position. Then, the CPU 501 completes the operation of the maintenance apparatus 30.

FIG. 6 is a diagram showing a state in which the cap unit 314 abuts on the nozzle surface 203 in Act 1009. The elastic member 3144 abutting on the nozzle surface 203 elastically changes due to the weight of the spring unit 3142. The elastic member 3144 tightly adheres to the nozzle surface 203. The first protrusion 3144a faces the nozzle array 204a. The upper portion of the first protrusion 3144a tightly closes all nozzle holes constituting the nozzle array 204a. Similarly, the second protrusion 3144b faces the nozzle array 204b. The upper portion of the second protrusion 3144b tightly closes all nozzle holes constituting the nozzle array 204b. In addition, the elastic member 3144 may be configured such that the cap unit 314 enters into each nozzle hole, if the cap unit 314 abuts on the nozzle surface 203 by adjusting the elasticity of the spring unit 3142.

According to this embodiment, the ink adhering to the upper portion of the first protrusion 3144a flows to the base unit 3143 or the groove 3144c along the surface of the first protrusion 3144a even if the cap unit 314 is separated from the nozzle surface 203. This is because the upper portion of the first protrusion 3144a is shaped such that the ink hardly remains. Similarly, the ink adhering to the upper portion of the second protrusion 3144b flows to the base unit 3143 or the groove 3144c along the surface of the second protrusion 3144b. This is because the upper portion of the second protrusion 3144b is shaped such that the ink hardly remains. The ink in the groove 3144c flows to the base unit 3143 due to the slope of the groove 3144c. Therefore, ink does not remain in the groove 3144c. In addition, the base unit 3143 may be provided with a discharge port so as to flow the remaining ink to the tank for storing waste liquid.

According to this embodiment, the ink adhering to the upper portion of the first protrusion 3144a does not flow to the upper portion of the second protrusion 3144b. That is, plural colors of ink are not mixed with each other at the upper portion of the first protrusion 3144a. Similarly, the ink adhering to the upper portion of the second protrusion 3144b does not flow to the upper portion of the first protrusion 3144a. That is, plural colors of ink are not mixed with each other at the upper portion of the second protrusion 3144b. Accordingly, the maintenance apparatus 30 can not only protect the nozzle surface 203 from paper powder, dust, and the like and avoid drying of the nozzle surface 203 but also prevent ink with a different color from the color of the ink discharged from the nozzle array 204a (the ink discharged from the nozzle array 204b) from adhering to the nozzle array 204a. Similarly, the maintenance apparatus 30 can prevent ink with a different color from the color of the ink discharged from the nozzle array 204b (the ink discharged from the nozzle array 204a) from adhering to the nozzle array 204b. Accordingly, the image forming apparatus 1 can prevent misdirection and ink clogging.

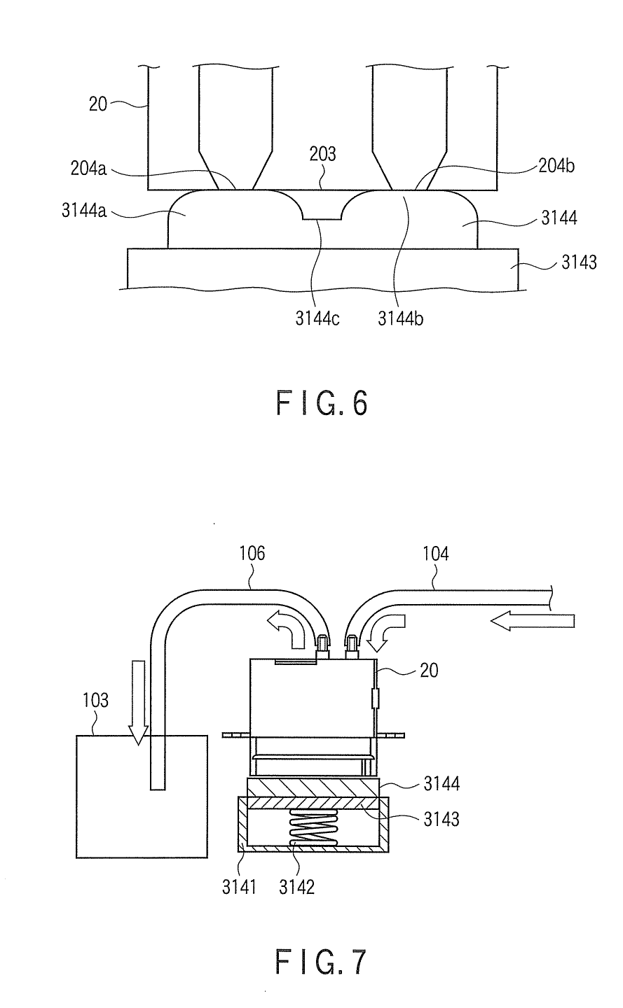

Next, description will be made of ink charging into the inkjet head 20. FIG. 7 is a diagram illustrating ink charging to the tubes 104 and 106 and the inkjet head 20. The CPU 501 controls the cap unit 53 to abut on the nozzle surface 203 and tightly close the nozzle arrays 204a and 204b with the first protrusion 3144a and the second protrusion 3144b before the start of the ink charging operation. Thereafter, the CPU 501 controls the first ink supply pump 1024, the second ink supply pump 1034, and the valves 1023 and 1033 to simultaneously charge the ink stored in the upstream-side tank 102 into the tube 104, the inkjet head 20, and the tube 106. Accordingly, the negative pressure within the inkjet head 20 is maintained in an appropriate state.

The CPU 501 controls the cap unit 53 to tightly close the nozzle arrays 204a and 204b before the start of the ink charging operation in order to prevent the ink leakage from the nozzle arrays 204a and 204b during the ink charging operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A maintenance unit comprising:
an inkjet head with plural nozzle arrays, which discharges different colors of ink from each of the plural nozzle arrays; and
a cap which includes plural protrusions at positions facing the plural nozzle arrays, includes a groove between the plural protrusions, and tightly closes the plural nozzle arrays with the plural protrusions.

2. The unit of claim 1 wherein the groove includes a slope along an arrangement direction of nozzles constituting the plural nozzle arrays.

3. The unit of claim 1 wherein each of the plural protrusions includes on an upper portion an arc-shaped surface in which a center in a direction perpendicular to an arrangement direction of nozzles corresponds to a peak.

4. The unit of claim 1 wherein each of the plural protrusions includes on an upper portion a plane with a size equal to or greater than a diameter of a nozzle constituting the plural nozzle arrays in a direction perpendicular to an arrangement direction of nozzles.

5. The unit of claim 1 wherein each of the plural protrusions includes an arc-shaped surface on at least one side in a direction perpendicular to an arrangement direction of nozzles.

6. The unit of claim 1 wherein the plural protrusions are constituted by an elastic member.

7. The unit of claim 1 wherein each of the plural protrusions includes an inclined surface on at least one side in a direction perpendicular to an arrangement direction of nozzles.

8. The unit of claim 7 wherein the cap includes a plate-shaped member, to which the plural protrusions are fixed, which includes a side wall surrounding the four sides of a surface to which the plural protrusions are fixed.

9. The unit of claim 1 comprising:
a spring provided beneath the plate-shaped member.

10. An image forming apparatus comprising:
an inkjet head with plural nozzle arrays, which discharges different color of ink from each of the plural nozzle arrays; and
a cap which includes plural protrusions at positions facing the plural nozzle arrays, includes a groove between the plural protrusions, and tightly closes the plural nozzle arrays with the plural protrusions,
a tank which stores ink, and
a tube which connects between the inkjet head and the tank.

11. The apparatus of claim 10 comprising:
a controller which performs control so as to circulate ink from the inkjet head to the tank.

12. The apparatus of claim 11 wherein the groove is inclined along an arrangement direction of nozzles constituting the plural nozzle arrays.

13. The apparatus of claim 11 wherein each of the plural protrusions includes on an upper portion an arc-shaped surface in which a center in a direction perpendicular to an arrangement direction of nozzles corresponds to a peak.

14. The apparatus of claim 11 wherein each of the plural protrusions includes on an upper portion a plane with a size equal to or greater than a diameter of a nozzle constituting the plural nozzle arrays in a direction perpendicular to an arrangement direction of nozzles.

15. The apparatus of claim 11 wherein each of the plural protrusions includes an arc-shaped surface on at least one side in a direction perpendicular to an arrangement direction of nozzles.

16. The apparatus of claim 1 wherein the plural protrusions are constituted by an elastic member.

17. The apparatus of claim 1 wherein each of the plural protrusions includes an inclined surface on at least one side in a direction perpendicular to an arrangement direction of nozzles.
